(19) United States
(12) Patent Application Publication
(10) Pub. No.: US 2022/0347874 A1
(43) Pub. Date: Nov. 3, 2022

(54) Razor With Adjustable Blades

(71) Applicant: Andrew L. Walker, Hillsborough, NC (US)

(72) Inventor: Andrew L. Walker, Hillsborough, NC (US)

(21) Appl. No.: 17/246,610

(22) Filed: May 1, 2021

(51) Int. Cl. B26B 21/40; B26B 21/52; B26B 21/22

(52) U.S. Cl. CPC B26B 21/4062; B26B 21/522; B26B 21/22

(57) ABSTRACT

A razor for grooming purposes that differs from other razors by having adjustable blades, which allow for shaving in an up direction where a non-adjustable razor would have to be physically positioned to shave in an up direction or any other direction. Additionally, the adjustable blades allow for faster cleaning as opposed to current razors.

### CROSS-REFERENCE TO RELATED APPLICATIONS

‘Not Applicable’

### STATEMENT REGARDING FEDERALLY SPONSORED RESEARCH OR DEVELOPMENT

‘Not Applicable’

### REFERENCE TO SEQUENCE LISTING, A TABLE, OR A COMPUTER PROGRAM LISTING COMPACT DISC APPENDIX

‘Not Applicable’

### BACKGROUND

This device (razor with adjustable blades) pertains to the areas of Bodily Grooming & Hygiene for Men and Women. Current shaving razors have fixed or immoveable blades that allow shaving in only a single direction and make cleaning of the blades difficult and time consuming.

### SUMMARY OF THE INVENTION

The razor has adjustable blades to hasten cleaning, thereby saving the user any time deducted from a pending engagement. (E.G. going to work, going to a social event, etc) The razor's adjustable blades also enables shaving in a different direction without physically orientating the razor.

### DRAWING VIEWS

FIG. 1—Bladehead Perspective

FIG. 2—Frontal perspective of entire razor showing internal component

FIG. 3—Side perspective of entire razor

FIG. 4—Cutaway side perspective of entire razor showing internal component

### DESCRIPTION

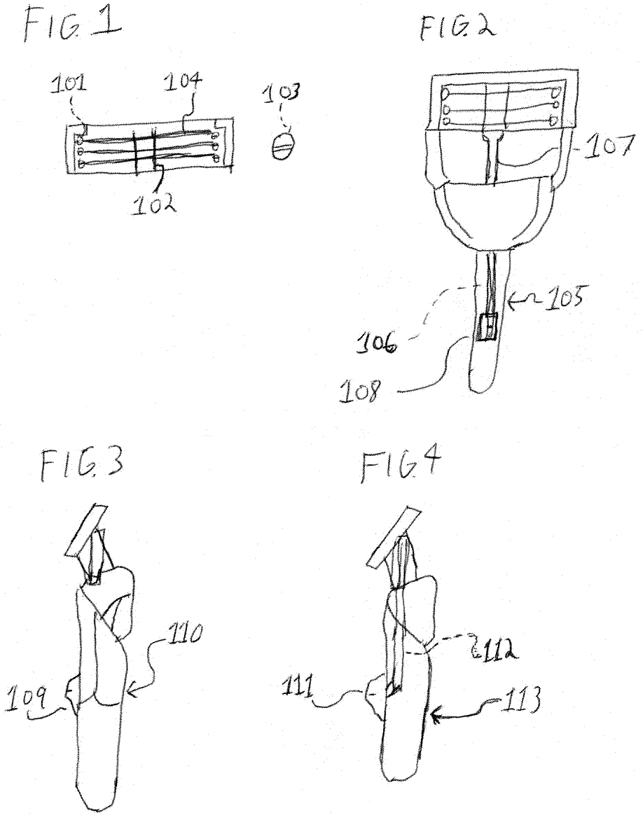

With reference to FIG. 1 showing a perspective razor bladehead, comprised of movable dials on each side of the bladehead 101, an example of the dial with a slot 103, along with a central shaft 102, with each individual blade being affixed into both the slotted dials and central shaft 104.

With reference to FIG. 2 showing a perspective view of the entire razor 105, with the connecting central shaft from the bladehead to the razor handle 107, next the connecting shaft continues down into the razor handle 106 and lastly connects to the sliding lever that adjusts the blades when the handle lever is moved into either the ‘up’ or ‘down’ position 108.

With reference to FIG. 3 showing a perspective side view of the entire shaving razor 110, including the sliding lever on the razor handle 109.

With reference to FIG. 4 showing a cutaway perspective side view of the entire razor 113, including the connecting shaft 112, which is attached to the sliding lever 111.

1. A razor with a bladehead having adjustable blades.

2. The razor of claim 1 wherein said bladehead has slotted dials on each side of the bladehead to hold the blades thereby helping to provide blade movement.

3. The razor of claim 1, further comprising in the bladehead, a central shaft which holds the blades to help provide blade movement in conjunction with the slotted dials, with the bladehead central shaft continuing down into the razor handle.

4. The razor of claim 1, further comprising the handle, is the connection shaft internal component leading from the bladehead, which connects to the handle sliding lever, where when lever is positioned ‘up’ or ‘down’ blade movement is perpetuated via the bladehead shaft and slotted dials.
